(19) United States
(12) Patent Application Publication
(10) Pub. No.: US 2010/0253613 A1
(43) Pub. Date: Oct. 7, 2010

(54) LED BACKLIGHT AND ELECTRONIC CONTROL

(75) Inventors: William DUNN, Alpharetta, GA (US); John Schuch, Buford, GA (US); Robert Cauffield, Lawrenceville, GA (US)

Correspondence Address: STANDLEY LAW GROUP LLP, 6300 Riverside Drive, Dublin, OH, 43017, US

(73) Assignee: MANUFACTURING RESOURCES INTERNATIONAL, INC., Alpharetta, GA (US)

(21) Appl. No.: 12/572,896

(22) Filed: Oct. 2, 2009

Related U.S. Application Data
(60) Provisional application No. 61/102,355, filed on Oct. 2, 2008.

(51) Int. Cl. G09G 3/36

(52) U.S. Cl. 345/102

(57) ABSTRACT

Embodiments comprise a backlight device and a method for controlling the chromaticity and/or luminance of the backlight device. More particularly, embodiments relate to a backlight device for a display which utilizes an array of LED pairs to create a desired chromaticity and luminance of light, whereby the chromaticity and luminance can be closely monitored and maintained throughout the life of the display. A pair of LEDs are used in an exemplary embodiment where the pair contains two blue LEDs with the first LED coated in a red phosphor and the second LED coated in a green phosphor.

### CROSS-REFERENCE TO RELATED APPLICATIONS

This non-provisional patent application claims priority to co-pending U.S. Application 61/102,355 filed on Oct. 2, 2008.

### TECHNICAL FIELD

Embodiments relate generally to a backlight device and a method for controlling the chromaticity of the backlight device. Exemplary embodiments relate to a backlight device for a liquid crystal display (LCD) which utilizes an array of LED pairs to create a desired chromaticity of white light, whereby the chromaticity can be closely monitored and maintained throughout the life of the display.

### BACKGROUND OF THE ART

Liquid crystal displays (LCD) typically utilize a backlight device in order to produce an image upon the viewable screen. The backlight is typically a white light which is then given its appropriate color when it passes through the LCD stack. Additionally, backlights are used in several other displays including static displays. These displays comprise a stationary graphic which is backlight in order to aid in viewing. Recently, the electronics industry has begun to utilize light emitting diodes (LEDs) as the light source for backlights in LCD displays. In the past, either white LEDs or a combination of red, green, and blue LEDs have been used to create the white-colored backlight.

Some applications require the light emitted from a backlight to possess a specific chromaticity. This is important in fields such as LCD avionics, where the colors displayed on a critical-function aircraft display must be exact. This is also important in high-definition LCD displays and static advertising displays. A slight difference in chromaticity of the backlight might adversely affect the color of the display. However, most commercially-available LEDs are produced with a limited number of chromaticity choices.

Furthermore, available LEDs are typically mass-produced and exhibit chromaticities within a certain range. This means that even if the rated chromaticity of an available LED matches the chromaticity requirements for an LCD backlight design, the rated chromaticity may be different from the actual chromaticity. In an array of white LEDs, there may be many individual LEDs that do not match the rated chromaticity, and the total chromaticity of the array may therefore not be predictable. These variations in the actual chromaticity of each LED is furthered when red, green, and blue LEDs must be combined together, and controlling the proper amounts of red, green, and blue can become complicated and expensive.

Furthermore, there may be some change in LED chromaticity over time. The chromaticity may also be affected by variations in temperature. Additionally, one or more LEDs in the array may be faulty and either fail prematurely or emit light with an unintended chromaticity. In any case, the chromaticity of the entire array may be affected. In demanding applications such as avionics and high-definition displays it is possible that such a chromaticity change would necessitate untimely repair or removal of the backlight.

Additional embodiments utilize the backlight device disclosed herein for static advertising displays where an exemplary backlight is installed behind a graphic so that it may be viewable in low-light conditions or simply appear brighter and more vibrant in standard light conditions.

### SUMMARY OF THE EXEMPLARY EMBODIMENTS

Exemplary embodiments control a pair of LEDs to create the desired chromaticity, and maintain this chromaticity throughout the life of the backlight. If the desired chromaticity is white, an exemplary embodiment may utilize a blue LED with an orange (or red) phosphor coating in combination with another blue LED which has a green phosphor coating. These white-light-producing LED chips, or bi-packs, are currently available through Lumimicro Corp, Ltd. of Korea. www.lumimicro.com. Exemplary embodiments contain a plurality of the LED pairs and set the relative power of the two types of LEDs precisely during manufacturing and then monitor and control the relative power of the two throughout the life of the backlight.

It should be noted that the exemplary embodiment as noted above (blue LEDs with orange/red and green phosphor coatings) are used to describe the setup and function of the system throughout this disclosure, only for simplification purposes. It should be noted that a number of other color combinations could be used and still fall within the scope of the invention. For example, red LEDs could be used with a blue phosphor and a red/orange phosphor. Taken further, a combination of any number of LED colors and phosphor colors can be used to create the desired chromaticity. Again, the blue LEDs with orange/red and green phosphor coatings are used herein for exemplary purposes only.

Exemplary embodiments compensate for naturally occurring variations in the manufacturing of LEDs so that light with a predictable chromaticity is supplied. An advantage of the invention is that commonly available LEDs may be used in a backlight even if the chromaticity of the commonly available LEDs is different from the desired chromaticity.

Further, embodiments spatially resemble the common backlight structures currently in mass-manufacturing, so that they can be easily adapted into existing LCD layouts and existing static displays. Also, the controlling of the system is simple and cost-effective. Embodiments create a precise, desired white chromaticity, and monitor this chromaticity as LED lights degrade or fail and possibly vary their color due to temperature changes. Embodiments are extremely useful in displays which must function through a large range of temperatures, specifically for any display that may be used outdoors. Exemplary embodiments also extend the useful lifetime of an LED-based backlight.

### BRIEF DESCRIPTION OF THE DRAWINGS

A better understanding of the exemplary embodiments of the invention will be had when reference is made to the accompanying drawings, wherein identical parts are identified with identical reference numerals, and wherein:

FIG. 1 is a top view of the LED pair;

FIG. 2 is a front view of an embodiment of a backlight assembly which utilizes the LED pair from FIG. 1;

FIG. 3 is a side view of an embodiment of an LCD assembly using the backlight assembly from FIG. 2;

FIG. 4 is a schematic of an embodiment for calibrating the backlight assembly;

FIG. 5 is logic diagram for the calibration of the backlight assembly;

FIG. 6 is a schematic of an embodiment for controlling the chromaticity of the backlight assembly;

FIG. 7 is a logic diagram for the controlling of the chromaticity of the backlight assembly throughout operation of a display;

FIG. 8 is logic diagram for the calibration of the backlight assembly where both the chromaticity and the luminance are measured; and

FIG. 9 is a logic diagram for the controlling of the chromaticity and the luminance of the backlight assembly throughout operation of a display.

### DETAILED DESCRIPTION OF A PREFERRED EMBODIMENT

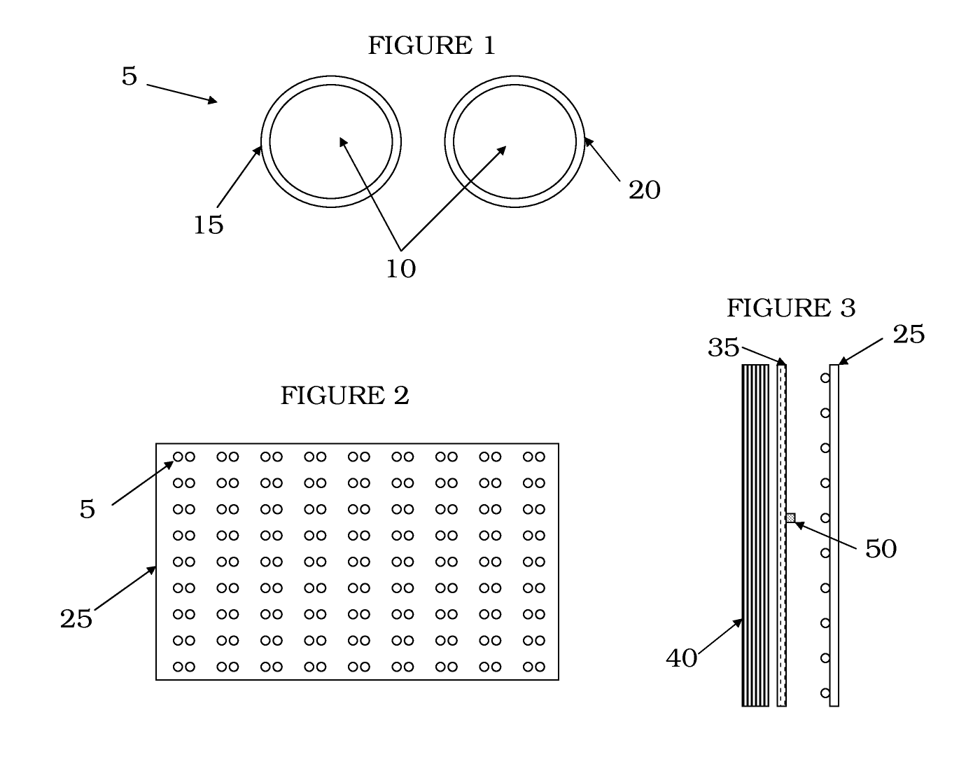

Turning to the drawings for a better understanding, FIG. 1 shows a top view of the LED pair 5. Two blue LEDs 10 are used. One blue LED 10 is coated with a green phosphor 15 while the other blue LED 10 is coated with a red or orange phosphor 20. Together, the LED pair 5 produces white light.

FIG. 2 shows a front view of a backlight assembly 25 using a plurality of the LED pairs 5. The LED pairs 5 could be oriented in any fashion that is appropriate for the application. Less or more LED pairs 5 may be used in any embodiment. The LEDs may be mounted on a printed circuit board (PCB). The PCB may have a low level of thermal resistance between the surface containing the LEDs and the opposite surface. This low level of thermal resistance may allow heat to dissipate from the surface containing the LEDs to the opposite surface and ultimately away from the PCB. Metal PCB technology may be used to accomplish this heat transfer. Heat may be dissipated from the rear surface of the PCB by passing air over the rear surface. The rear surface of the PCB may also be metallic and may contain heat fins or other surface features to help remove the heat.

FIG. 3 shows the basic setup for an LCD display. The LCD stack 40 generates the image and contains several layers. Within the LCD stack may be the liquid crystal material, conductive elements, and several other layers which polarize light or protect the display. The details of these layers are not critical to the invention so they will not be discussed further. An embodiment which utilizes the backlight with a static display would have a similar setup, except the complicated LCD stack 40 would be replaced by a static graphic.

Between the backlight assembly 25 and the LCD stack 40 may be a light scattering device or diffuser 35. Placed in front of the backlight assembly 25 is a RGB or RGBW photosensing device 50. This may be placed in front of or behind the light scattering device or diffuser 35. One example of such a device would be the TAOS TCS230, but any equivalent would also suffice.

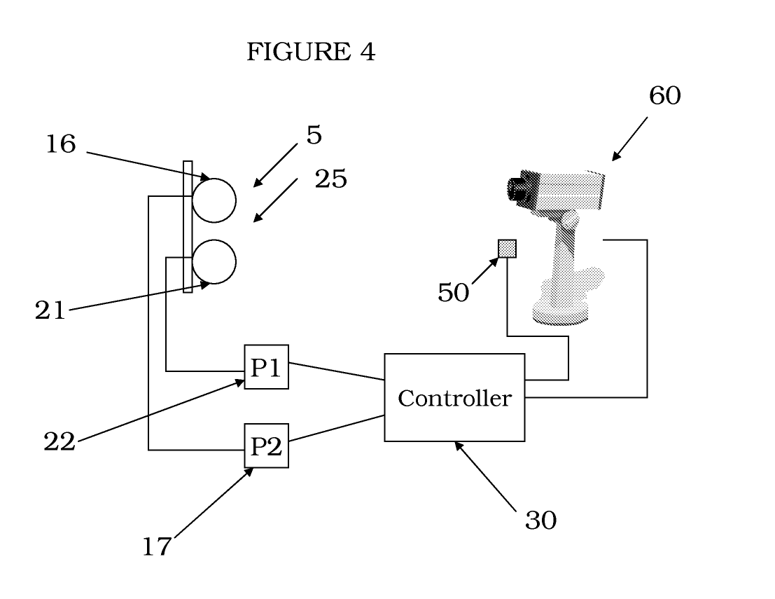

FIG. 4 is a schematic of an embodiment for calibrating the backlight assembly. The blue LED with green phosphor 16 may be powered by the P2 power source 17. The blue LED with red or orange phosphor 21 may be powered by the P1 power source 22. Note that only one pair of LEDs 5 is shown, but embodiments can control a plurality of pairs of LEDs 5. The controller 30 may be connected to each power source. The controller 30 may comprise several electronic devices including PCB assemblies, microcontrollers, amplifiers, signal processors, resistors, capacitors, and gates. For calibration purposes, a device 60 for measuring the chromaticity (and sometimes luminance) of the light coming from the backlight assembly 25 is also connected to the controller 30. This device 60 may be a spectroradiometer, colorimeter, or photometer. One device of such capacity is the PR-650 SpectraScan® Colorimeter from Photo Research®, but any equivalent will suffice. Photo Research® is located in Chatsworth, Calif. www.photoresearch.com

A photosensor 50 is connected to the controller 30 and placed so that it may detect and measure light coming from the LED pairs 5. This photosensor 50 may be placed anywhere between the diffuser 35 and the backlight assembly 25 or between the diffuser 35 and the LCD stack 40. Any location will suffice, so long as the photosensor 50 can adequately detect the light coming from the various LED pairs 5. The photosensor 50 is used to sense the chromaticity (and sometimes luminance) of the light that is coming from the LED pair(s) 5. One method for sensing the color coming from the backlight assembly is disclosed in “Sensing color with the TAOS TCS230” by Charles Poynton (www.poynton.com). This instructional manual is incorporated entirely by reference herein. This procedure is exemplary, and any method for using the photosensor 50 to sense the chromaticity, or both chromaticity and luminance, of the light illuminating from the backlight assembly will suffice.

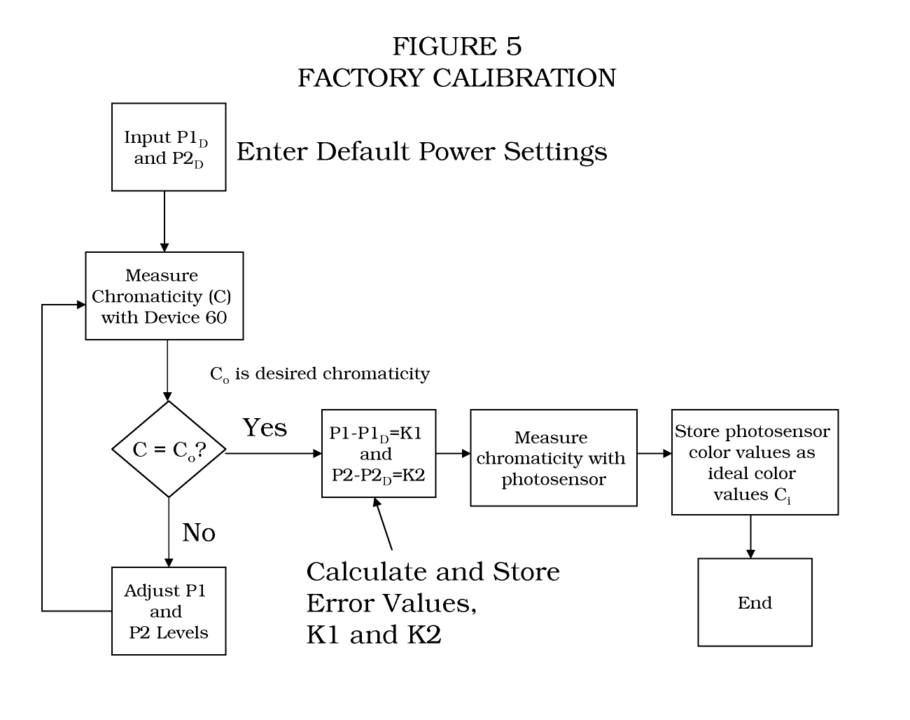

FIG. 5 is a logic diagram for the logic that may be performed by the controller 30 during the calibration of the backlighting assembly. Prior to calibration, the precise chromaticity for the desired level of white for the backlight is selected (Cₒ). The backlight assembly is initially powered up using default values for P1 and P2 (P1_{D} and P2_{D}). The chromaticity of the generated light is then measured using the device 60, which may be a colorimeter. The measured chromaticity (C) is then compared to the desired chromaticity (Cₒ). If these values are not equal or where C does not fall within an acceptable range surrounding Cₒ, then the relative power to LEDs 16 and 21 are adjusted until the desired Cₒ is reached.

For example, suppose that upon using the default values for P1 and P2, device 60 is indicating that there is too much green in the resulting light from the LEDs. The system would then alter the relative power of P1 (orange/red) and P2 (green). The system may accomplish this by decreasing P2 while holding P1 constant. Alternatively, the system may increase P1 while holding P2 constant. The particular method that is chosen may depend upon the desired level of luminance, which will be further discussed below.

Once the desired chromaticity is reached, the resulting P1 and P2 power levels are compared to the default values for P1 and P2 (P1_{D} and P2_{D}). The difference between these two amounts is considered the “error value” and is known in FIG. 5 as K1 and K2 respectively. These values may be stored by the controller 30. Also, once the desired Cₒ is reached, the chromaticity may be measured by the photosensor 50. These color values may be stored as the ideal color values C. The controller 30 may contain microprocessors and memory devices to perform these calculations and store the resulting values.

The calibration process may be performed during manufacturing of the LCD display or static display. The calibration process may also be performed on displays which appear to be malfunctioning in the field or may have changed color over time due to failures or degradation of the LEDs.

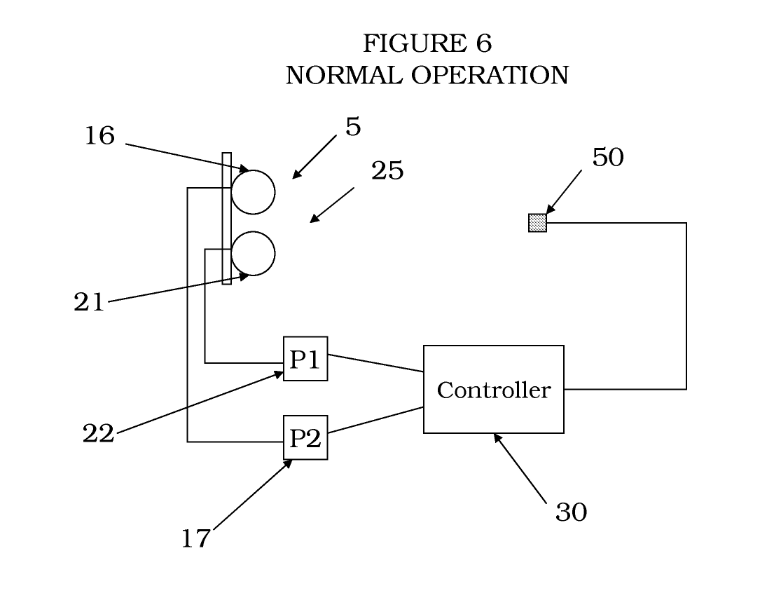

FIG. 6 is a schematic for controlling the chromaticity of the backlight assembly during operation. Again, power sources P1 and P2 power LEDs 21 and 16 respectively. Also, although only one pair of LEDs 5 is shown, embodiments can control a plurality of pairs of LEDs 5. The controller 30 may again be connected to each of the power sources 22 and 17. During normal operation of the display, photosensor 50 is used to measure the ideal color values C₁. The photosensor 50 is again placed in electrical communication with the controller 30.

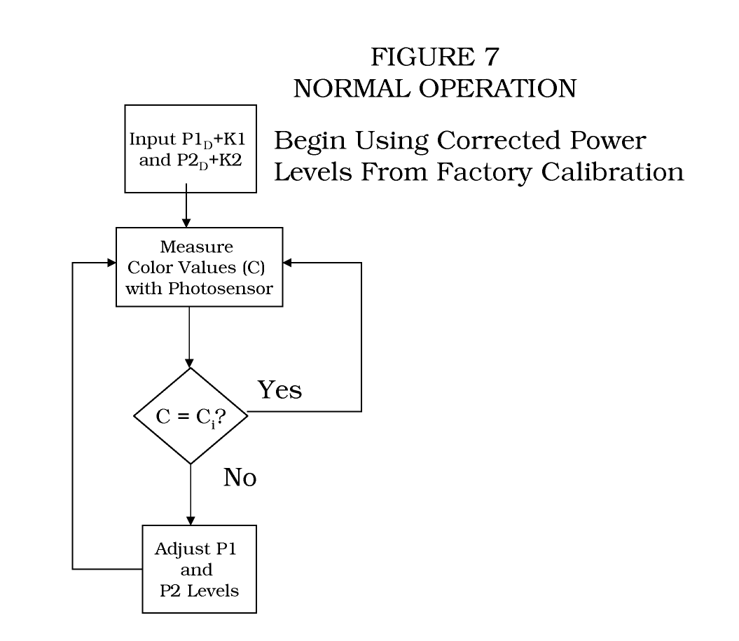

FIG. 7 shows an embodiment for the logic diagram for the controlling of the chromaticity and luminance of the backlight assembly throughout operation of the LCD device. The LED pairs 5 are initially powered using the default power levels P1_{D} and P2_{D} with their associated error values K1 and K2 determined during calibration.

The photosensor 50 frequently measures the chromaticity of the light and compares this measurement with the ideal color values Cᵢ which were stored previously during calibration. If the color measurement is equal to C, or within an acceptable range surrounding Cᵢ, the system makes no changes to P1 or P2, and returns again after a brief pause to re-measure the color values. If the current measurement of color values is not equal to C, or within an acceptable range surrounding Cᵢ, then P1 and P2 are adjusted, and the system again re-measures the color values to determine whether the adjustment has now made the current color values equal to Cᵢ or within the acceptable range.

During operation, the system may adjust the relative power of P1 and P2 in a similar manner as disclosed above during calibration. For example, suppose that photosensor 50 is indicating that there is too much green in the resulting light from the LEDs. The system would then alter the relative power of P1 (orange/red) and P2 (green). The system may accomplish this by decreasing P2 while holding P1 constant. Alternatively, the system may increase P1 while holding P2 constant. The particular method that is chosen may depend upon the desired level of luminance, which will be further discussed below.

The system may measure the color values of the backlight assembly several times per second. This constant measuring and adjustment allows the backlight assembly to maintain a consistent chromaticity throughout the life of the backlight assembly. Further, if the backlight were to begin generating light outside the desired chromaticity, this would only happen for a brief period of time before system correction.

In addition to setting and controlling the chromaticity of the backlight, the luminance may also be set and controlled. Using the exemplary embodiment described above (blue LEDs with red/orange and green phosphor), it has been found that while the relative power levels of the LEDs will control the chromaticity, the luminance level is largely controlled by the blue which is coming from the blue LEDs. Thus, increasing the overall power to the LEDs while keeping the relative power between the two types of LEDs constant, will result in a relatively constant chromaticity but with increased luminance.

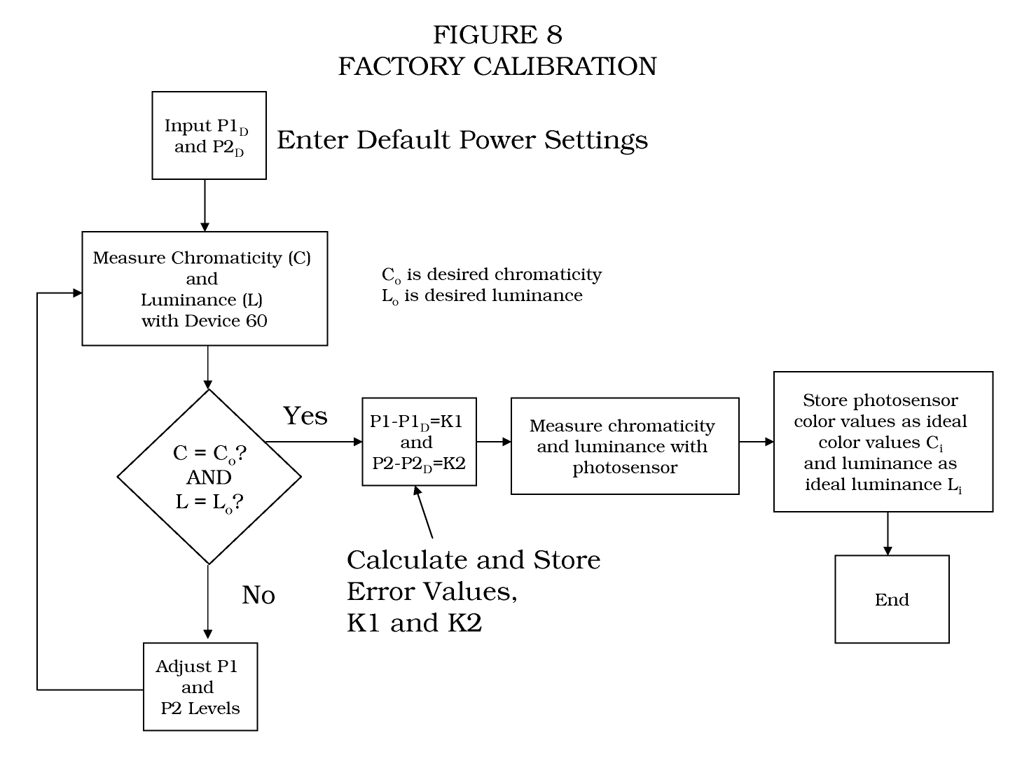

FIG. 8 shows a logic diagram for the calibration of the backlight assembly where both the chromaticity and the luminance are measured. Here, the process for adjusting P1 and P2 has an additional step of increasing or decreasing the overall power to the LEDs in order to increase or decrease the luminance. Thus, the system may adjust the relative power between the two types of LEDs (to control chromaticity) and also adjust the overall power to the LEDs (to control luminance). The specific steps can be in any order, i.e. the chromaticity may be determined first and then the proper luminance, or the luminance may be determined first and then the chromaticity, or both properties may be set simultaneously.

It should be noted, that if the two properties are determined in series, the system should again check both values before ending the calibration. For example, if the proper chromaticity is determined first and the luminance second, an exemplary embodiment should re-measure and calibrate the chromaticity prior to ending the calibration process. Thus, an exemplary embodiment may alternate between chromaticity measurement/adjustment and luminance measurement/adjustment until the preferred chromaticity and luminance is achieved.

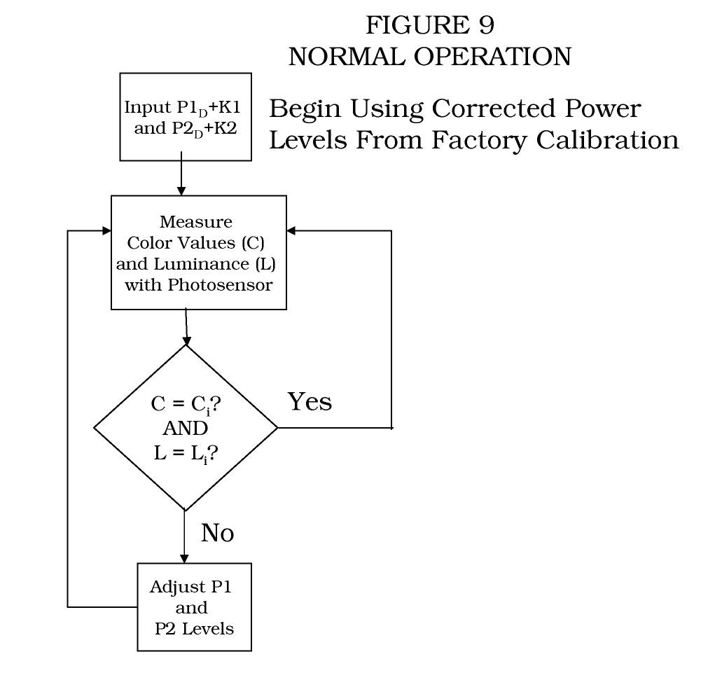

FIG. 9 shows a logic diagram for controlling the chromaticity and the luminance of the backlight assembly throughout operation of a display. This logic works similar to that which was described above in FIG. 7, except this system also measures and controls the luminance of the backlight.

The photosensor 50 frequently measures the chromaticity of the light and compares this measurement with the ideal color values C, which were stored previously during calibration. The photosensor 50 also measures the luminance of the light and compares this measurement with the ideal luminance value L. Both C, and L, may have acceptable ranges and where the measured values do not fall within the acceptable ranges, P1 and P2 are adjusted.

During operation, the system may adjust the relative power of P1 and P2 in a similar manner as disclosed above during calibration. The system may measure/adjust both properties simultaneously or may proceed with each property one at a time. The system may measure the color values and luminance of the backlight assembly several times per second. This constant measuring and adjustment allows the backlight assembly to maintain a consistent chromaticity and luminance throughout the life of the backlight assembly and to quickly adjust the settings when the measured values fall outside of the acceptable range.

Having shown and described a preferred embodiment of the invention, those skilled in the art will realize that many variations and modifications may be made to affect the described invention and still be within the scope of the claimed invention. Additionally, many of the elements indicated above may be altered or replaced by different elements which will provide the same result and fall within the spirit of the claimed invention. It is the intention, therefore, to limit the invention only as indicated by the scope of the claims.

What is clamed is:

1. A backlight device comprising:
a first plurality of LEDs comprising a plurality of LEDs which are coated with phosphor of a first color;
a second plurality of LEDs comprising a plurality of LEDs which are coated with phosphor of a second color;
a first power source operatively connected to said first plurality of LEDs;
a second power source operatively connected to said second plurality of LEDs;
a light-sensing device capable of sensing the chromaticity of the light emitted from said first and second plurality of LEDs, and
a controller operatively connected to said first power source, said second power source, and said light-sensing device such that the controller is capable of controlling the power of each power source based on data which is received from said light-sensing device.

2. The backlight device from claim 1 wherein:
said first plurality of LEDs comprise blue LEDs which are coated in a green phosphor, and
said second plurality of LEDs comprise blue LEDs which are coated in a red phosphor.

3. The backlight device from claim 1 wherein:
said first plurality of LEDs comprise blue LEDs which are coated in a green phosphor, and
said second plurality of LEDs comprise blue LEDs which are coated in an orange phosphor.

4. The backlight device of claim 1 wherein said light-sensing device is a photosensor.

5. The backlight device of claim 4 wherein said controller comprises a microcontroller.

6. A liquid crystal display backlight device comprising:
a first blue LED which is coated with a green phosphor;
a second blue LED which is coated with a red phosphor; and
circuitry in electrical communication with the first and second LEDs effective for maintaining a desired chromaticity and luminance by controlling the power sent to the respective LEDs.

7. The backlight device from claim 6 wherein the light output from the LEDs combines to produce white light.

8. The backlight device from claim 7 wherein said circuitry includes a photometer.

9. A method for maintaining the chromaticity of a backlight assembly, said method comprising the steps of:
providing a backlight assembly comprising:
a first plurality of LEDs comprising a plurality of LEDs which are coated with phosphor of a first color;
a second plurality of LEDs comprising a plurality of LEDs which are coated with phosphor of a second color;
a first power source operatively connected to said first plurality of LEDs;
a second power source operatively connected to said second plurality of LEDs;
a light-sensing device capable of sensing the chromaticity of the light emitted from said first and second plurality of LEDs, and
a controller operatively connected to said first power source, said second power source, and said light-sensing device such that the controller is capable of controlling the power of each power source based on data which is received from said light-sensing device;
selecting a desired chromaticity range for the light from the backlight assembly;
applying default power levels to said first and second power sources;
measuring the chromaticity of the light from the backlight assembly; and
comparing the measured chromaticity with the desired chromaticity range and adjusting the power of the first and second power sources if the measured chromaticity is not within the desired range.
